(19) United States
(12) Patent Application Publication
(10) Pub. No.: US 2026/0129605 A1
(43) Pub. Date: May 7, 2026

(54) ENHANCEMENT ON OPEN LOOP POWER CONTROL FOR ATG UES

(71) Applicant: APPLE INC., Cupertino, CA (US)

(72) Inventors: Yuexia Song, Beijing (CN); Manasa Raghavan, Sunnyvale, CA (US); Yang Tang, San Jose, CA (US); Dawei Zhang, Saratoga, CA (US); Xiang Chen, Campbell, CA (US); Qiming Li, Beijing (CN); Jie Cui, San Jose, CA (US); Rolando E Bettancourt Ortega, Munich (DE)

(21) Appl. No.: 19/122,591

(22) PCT Filed: Nov. 4, 2022
(86) PCT No.: PCT/CN2022/130009

§ 371 Date: Apr. 18, 2025

(51) Int. Cl. H04W 64/00; H04W 52/10; H04W 52/36

(52) U.S. Cl. CPC H04W 64/00; H04W 52/10; H04W 52/367

(57) ABSTRACT

The disclosure relates to enhancement on open loop power control for ATG UEs. In some embodiments, there is provided a user equipment (UE), comprising at least one antenna, at least one radio coupled to the at least one antenna and a processor coupled to the at least one radio. The processor is configured to perform location based open loop power control comprising: receiving, from a base station, a location and an antenna gain pattern of the base station; determining a location of the UE; and determining an initial transmission power of the UE for the location based open loop power control based on the location of the UE, the location of the base station and the antenna gain pattern of the base station.

### TECHNICAL FIELD

This application relates generally to wireless communication systems, including user equipments (UEs), base stations (BSs), methods, apparatus, and medium for enhancement on open loop power control for Air-to-Ground (ATG) UEs.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to user equipments (UEs), base stations, methods, apparatus, and medium for enhancement on open loop power control for ATG UEs.

In one aspect, there is provided a user equipment (UE), comprising at least one antenna, at least one radio coupled to the at least one antenna and a processor coupled to the at least one radio. The processor is configured to perform location based open loop power control comprising: receiving, from a base station, a location and an antenna gain pattern of the base station; determining a location of the UE; and determining an initial transmission power of the UE for the location based open loop power control based on the location of the UE, the location of the base station and the antenna gain pattern of the base station.

In another aspect, there is provided a method, comprising: by a user equipment (UE), performing location based open loop power control comprising: receiving, from a base station, a location and an antenna gain pattern of the base station; determining a location of the UE; determining an initial transmission power of the UE for the location based open loop power control based on the location of the UE, the location of the base station and the antenna gain pattern of the base station.

In another aspect, there is provided an apparatus for operating a user equipment (UE), comprising: a processor configured to cause the UE to perform a method as recited above.

In another aspect, there is provided a non-transitory computer-readable memory medium storing program instructions which, when executed at a user equipment (UE), cause the UE to perform a method as recited above.

In another aspect, there is provided a base station (BS), comprising at least one antenna, at least one radio coupled to the at least one antenna, and a processor coupled to the at least one radio. The processor is configured to determine a location and an antenna gain pattern of the base station and broadcast to a UE the location and the antenna gain pattern of the base station, the location and the antenna gain pattern of the base station being used by the UE along with a location of the UE to determine an initial transmission power of the UE for location based open loop power control.

In another aspect, there is provided a method, comprising: by a base station (BS) determining a location and an antenna gain pattern of the base station; and broadcasting to a UE the location and the antenna gain pattern of the base station, the location and the antenna gain pattern of the base station being used by the UE along with a location of the UE to determine an initial transmission power of the UE for location based open loop power control.

In another aspect, there is provided an apparatus for operating a base station (BS), comprising a processor configured to cause the BS to perform a method as recited above.

In another aspect, there is provided a non-transitory computer-readable memory medium storing program instructions which, when executed at a base station (BS), cause the BS to perform a method as recited above.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example flowchart of a method performed by a UE, according to embodiments disclosed herein.

FIG. 4 illustrates an example flowchart of a method performed by a UE, according to embodiments disclosed herein.

FIG. 5 illustrates an example flowchart of a method performed by a UE, according to embodiments disclosed herein.

FIG. 6 illustrates an example flowchart of a method performed by a UE for Reference Signal Receiving Power (RSRP) measurement based open loop power control, according to embodiments disclosed herein.

FIG. 7 illustrates an example flowchart of a method 700 performed by a base station, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

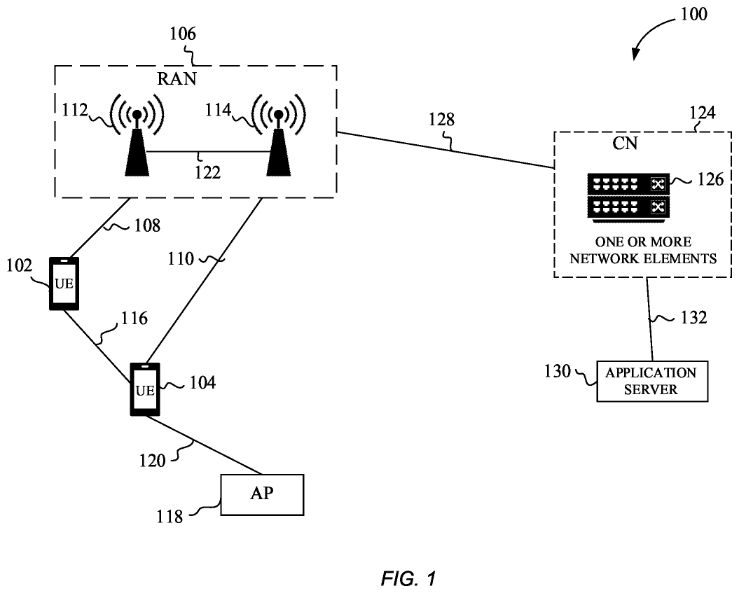

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR. In a case that the RAN 106 is an NTN-based NG-RAN architecture, the connection 108 and connection 110 are NR Uu interfaces.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

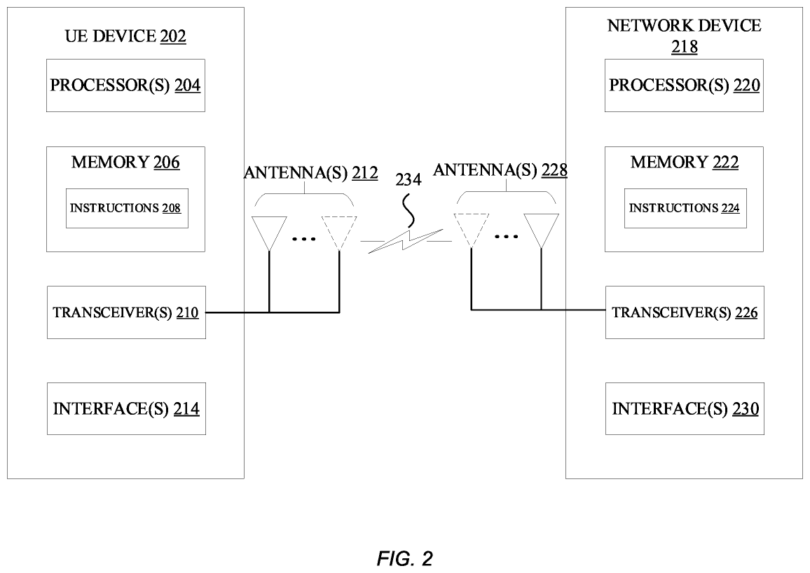

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs. The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Air-to-ground (ATG) network refers to in-flight connectivity technique, using ground-based cell towers that send signals up to an aircraft's antenna(s) of onboard ATG terminal.

Open loop power control is used by a UE during random access process. For Terrestrial Networks (TN) system, the UE may determine initial transmission power P_{PRACH,b,f,c} for the open loop power control according to the following formula:

$${P}_{PRACH , b , f , c} = mim \{ {P}_{cmax , f , c} , {P}_{PRACH , target , f , c} * P {L}_{b , f , c} \} \qquad ( 1 )$$

wherein P_{cmax,f,c} is a configured maximum output power of the UE with a specified tolerance specified e.g., in 3GPP TS 38.101-1 for FR1 and 3GPP TS 38.101-2 for FR2,
P_{PRACH,target,f,c} is an expected receiving power of PRACH at a base station (e.g., gNB), and P_{RACH,target,f,c} may be signaled by the base station in broadcast information for the UE,
PL_{b,f,c} is a calculated value between downlink reference signal power signaled by the base station and Reference Signal Receiving Power (RSRP) measured by the UE. For example, the accuracy of the measured RSRP is specified in 3GPP TS 38.133.

As can be seen, the open loop power control error is dominated by two parts, wherein one part is the power setting tolerance of P_{cmax,f,c} and the other part is due to the error from the RSRP measurement. According to current open loop power control requirement e.g., specified in 3GPP TS 38.101-1 for FR1, the power accuracy is as large as 9 dB which actually will have non-negligible impact on the random access success rate.

The situation for open loop power control for ATG system could be completely different as compared to that for TN network. An ATG gNB and an ATG UE can benefit from the Line of Sight (LOS) propagation condition, where the channel estimation can be much more accurate. An ATG gNB and an ATG UE can both be Global Navigation Satellite System (GNSS) capable. The ATG UE can benefit from GNSS information in getting much more accurate Pathloss (PL) information. The ATG UE may be fixed on the aircraft and moving on an airline trajectory.

The disclosure considers enhancement on open loop power control for ATG UEs for improving the random access success rate. In one aspect, the disclosure provides location based open loop power control, in which the base station broadcast its location and antenna gain pattern to a UE, and the UE determines initial transmission power for Physical Random Access Channel (PRACH) transmission based on the base station's location, the UE's location and the antenna gain pattern. In another aspect, the UE may determine whether to adopt the location based open loop power control or a RSRP measurement based open loop power control based on its location (more particularly, its altitude).

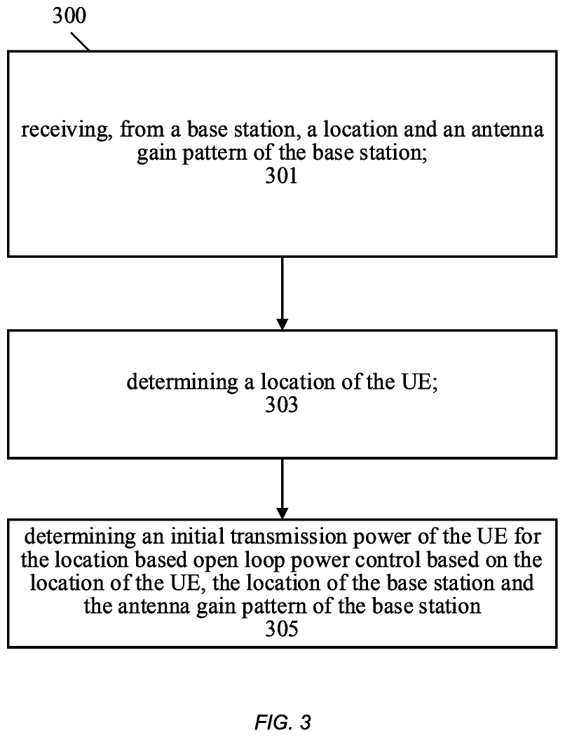

FIG. 3 illustrates an example flowchart of a method 300 performed by a UE, according to embodiments disclosed herein. The UE is configured to perform location based open loop power control.

As shown in FIG. 3, the method 300 may comprise an operation 301, at which the UE receives from a base station, a location and an antenna gain pattern of the base station. The base station may be GNSS capable, and determines its location based on GNSS information.

As shown in FIG. 3, the method 300 may further comprise an operation 303, at which the UE determines a location of the UE. The UE may be GNSS capable, and determines its location based on GNSS information.

As shown in FIG. 3, the method 300 may further comprise an operation 305, at which the UE determines an initial transmission power of the UE for the location based open loop power control based on the location of the UE, the location of the base station and the antenna gain pattern of the base station.

As the initial transmission power of the UE is determined in consideration of the location of UE, the location of the base station and the antenna gain pattern of the base station which are accurate, the initial transmission power may be determined more accurately and may enhance the open loop power control.

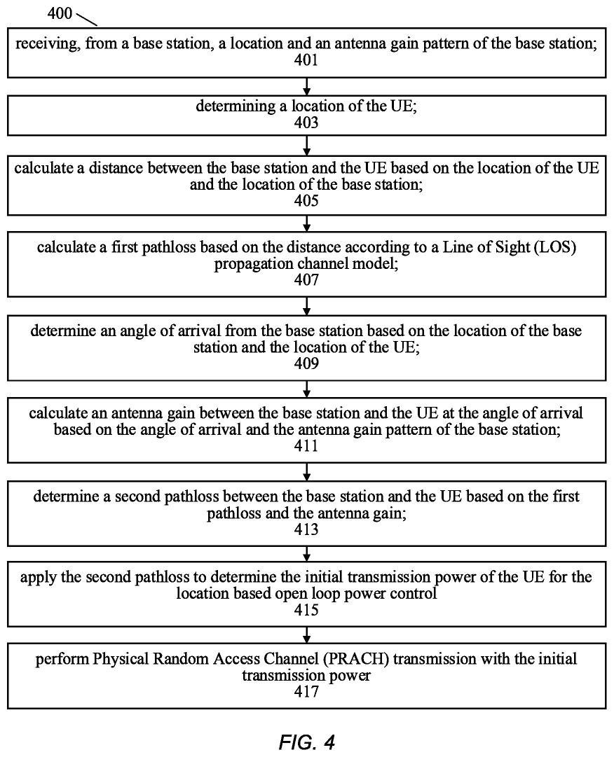

FIG. 4 illustrates an example flowchart of a method 400 performed by a UE, according to embodiments disclosed herein.

As shown in FIG. 4, the method 400 may comprise an operation 401, at which the UE may receive from a base station, a location and an antenna gain pattern of the base station.

As shown in FIG. 4, the method 400 may further comprise an operation 403, at which the UE may determine a location of the UE. The UE may be GNSS capable, and determines its location based on GNSS information.

As shown in FIG. 4, the method 400 may further comprise an operation 405, at which the UE may calculate a distance between the base station and the UE based on the location of the UE and the location of the base station.

As shown in FIG. 4, the method 400 may further comprise an operation 407, at which the UE may calculate a first pathloss based on the distance according to a Line of Sight (LOS) propagation channel model.

As shown in FIG. 4, the method 400 may further comprise an operation 409, at which the UE may determine an angle of arrival from the base station based on the location of the base station and the location of the UE. The reference direction for the angle of arrival may be predefined. The reference direction may be along the horizontal axis or the vertical axis.

As shown in FIG. 4, the method 400 may further comprise an operation 411, at which the UE may calculate an antenna gain between the base station and the UE at the angle of arrival based on the angle of arrival and the antenna gain pattern of the base station;

As shown in FIG. 4, the method 400 may further comprise an operation 413, at which the UE may determine a second pathloss between the base station and the UE based on the first pathloss and the antenna gain.

Since the GNSS accuracy is very high, the first pathloss can be very accurate. Further, since the antenna gain at angle of arrival based on the antenna gain pattern is also considered, the accuracy of the second pathloss can be very accurate.

As shown in FIG. 4, the method 400 may further comprise an operation 415, at which the UE may apply the second pathloss to determine the initial transmission power of the UE for the location based open loop power control.

In some embodiments, the UE may apply the second pathloss to the following formula:

$${P}_{PRACH , b , f , c} = mim \{ {P}_{cmax , f , c} , {P}_{PRACH , target , f , c} * P {L}_{positioning} \} \qquad ( 2 )$$

P_{PRACH,b,f,c} is the initial transmission power of the UE for the location based open loop power control,
P_{cmax,f,c} is a configured maximum output power of the UE,
P_{PRACH,target,f,c} is an expected receiving power at the base station, which may be broadcast by the base station, and
PL_{positioning} is the second pathloss.

That is, a minimum of the following can be determined as the initial transmission power of the UE: a maximum output power configured by the UE, and (ii) a product of an expected receiving power at the base station and the second pathloss.

As shown in FIG. 4, the method 400 may further comprise an operation 417, at which the UE may perform Physical Random Access Channel (PRACH) transmission with the initial transmission power.

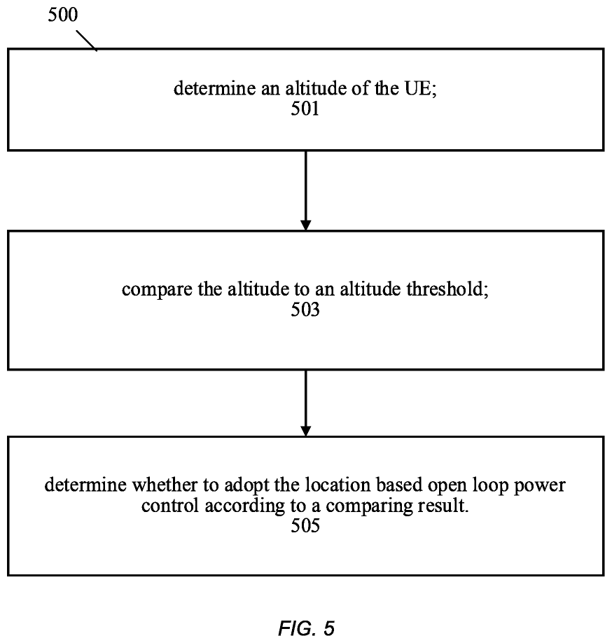

FIG. 5 illustrates an example flowchart of a method 500 performed by a UE, according to embodiments disclosed herein.

As shown in FIG. 5, the method 500 may comprise an operation 501, at which the UE may determine an altitude of the UE. The UE may determine its altitude based on GNSS information.

As shown in FIG. 5, the method 500 may further comprise an operation 503, at which the UE may compare the altitude to an altitude threshold.

The altitude threshold may be redefined to ensure line of sight condition between the UE and the base station. In some embodiments, the altitude threshold may be predefined as 3 km.

In some embodiments, the altitude threshold may be predefined for UEs. In some embodiments, the altitude threshold may be configured by the base station and is broadcast from the base station to the UE. The altitude threshold may be configured in System Information Block (SIB) or Radio Resource Control (RRC). The configured altitude threshold may be 3 km, but not limited to this. The altitude threshold may be configured in SIB/RRC.

As shown in FIG. 5, the method 500 may further comprise an operation 505, at which the UE may determine whether to adopt the location based open loop power control according to a comparing result.

If the comparing result indicates that the determined altitude is larger than the altitude threshold, the UE may determine to adopt the location based open loop power control, e.g., as described previously with respect to FIGS. 3-4.

If the comparing result indicates that the determined altitude is not larger than the altitude threshold, the UE may determine to adopt e.g., Reference Signal Receiving Power (RSRP) measurement based open loop power control.

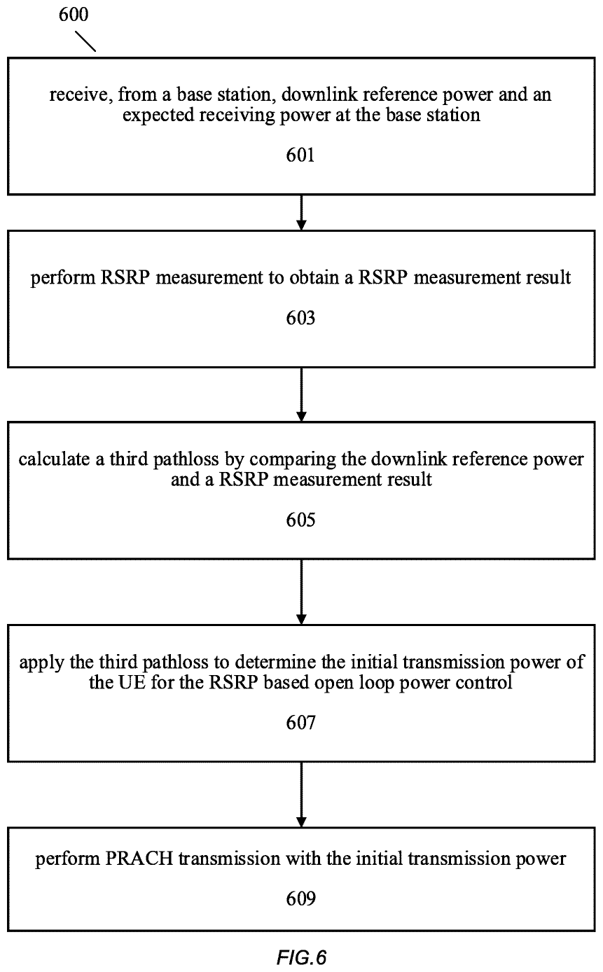

FIG. 6 illustrates an example flowchart of a method 600 performed by a UE for Reference Signal Receiving Power (RSRP) measurement based open loop power control, according to embodiments disclosed herein.

As shown in FIG. 6, the method 600 may comprise an operation 601, at which the UE may receive, from a base station, downlink reference power and an expected receiving power at the base station (e.g., P_{PRACH,target,f,c}).

As shown in FIG. 6, the method 600 may comprise an operation 603, at which the UE performs RSRP measurement to obtain a RSRP measurement result.

As shown in FIG. 6, the method 600 may comprise an operation 605, at which the UE may calculate a third pathloss by comparing the downlink reference power and a RSRP measurement result. The third pathloss may be determined based on the difference between the downlink reference power and the RSRP measurement result.

As shown in FIG. 6, the method 600 may comprise an operation 607, at which the UE may apply the third pathloss to determine the initial transmission power of the UE for the RSRP measurement based open loop power control.

In particular, the UE may determine the initial transmission power of the UE by the following formula:

$${P}_{PRACH , b , f , c} = mim {\{}_{Pcmax , f , c} , {P}_{PRACH , target , f , c} * P {L}_{b , f , c} \} \qquad ( 3 )$$

P_{PRACH,b,f,c} is the initial transmission power of the UE for the RSRP measurement based open loop power control,
P_{cmax,f,c} is a configured maximum output power of the UE,
P_{PRACH,target,f,c} is the expected receiving power at the base station, which is broadcast by the base station, and
PL_{b,f,c} is the third pathloss.

As shown in FIG. 6, the method 600 may comprise an operation 609, at which the UE may perform PRACH transmission with the initial transmission power.

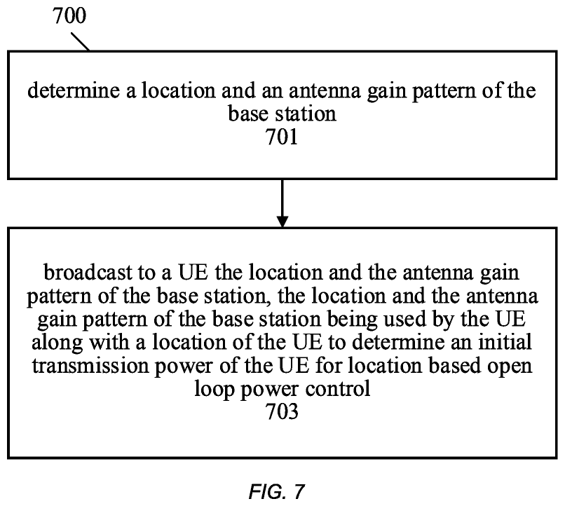

FIG. 7 illustrates an example flowchart of a method 700 performed by a base station, according to embodiments disclosed herein.

As shown in FIG. 7, the method 700 may comprise an operation 701, at which the base station may determine a location and an antenna gain pattern of the base station. The base station may be GNSS capable, and determines its location based on GNSS information.

As shown in FIG. 7, the method 700 may comprise an operation 703, at which the base station may broadcast to a UE the location and the antenna gain pattern of the base station, the location and the antenna gain pattern of the base station being used by the UE along with a location of the UE to determine an initial transmission power of the UE for location based open loop power control, e.g., as described with respect to FIGS. 3-4.

In some embodiments, the base station may broadcast an altitude threshold, wherein the UE determines whether to adopt the location based open loop power control according to a comparison result between an altitude of the UE and the altitude threshold, e.g., as described with respect to FIG. 5. The base station may broadcast the altitude threshold in a system information element.

The base station may broadcast a downlink reference signal power and an expected receiving power at the base station. The UE may use the downlink reference signal power and the expected receiving power in the RSRP measurement based open loop power control, and use the expected receiving power in the location based open loop power control. The base station may broadcast the downlink reference signal power and the expected receiving power in a system information element.

Although not shown, the method may further comprise an operation at which the base station may receive PRACH transmission sent by the UE. The PRACH transmission may be sent by the UE by performing location based open loop power control or RSRP measurement based open loop power control.

Embodiments contemplated herein include an apparatus comprising means to perform one or more elements of the method 300, 400, 500 and 600. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 300, 400, 500 and 600. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 300, 400, 500 and 600. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 300, 400, 500 and 600. This apparatus may be, for example, an apparatus of a UE (such as a wireless device 202 that is a UE, as described herein).

Embodiments contemplated herein include a signal as described in or related to one or more elements of the method 300, 400, 500 and 600.

Embodiments contemplated herein include a computer program or computer program product comprising instructions, wherein execution of the program by a processor is to cause the processor to carry out one or more elements of the method 300, 400, 500 and 600. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method 700. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 700. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 218 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways.

In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the processor is configured to perform location based open loop power control comprising:
receiving, from a base station, a location and an antenna gain pattern of the base station;
determining a location of the UE; and
determining an initial transmission power of the UE for the location based open loop power control based on the location of the UE, the location of the base station and the antenna gain pattern of the base station.

2. The UE of claim 1, wherein the processor is further configured to:
calculate a distance between the base station and the UE based on the location of the UE and the location of the base station;
calculate a first pathloss based on the distance according to a Line of Sight (LOS) propagation channel model;
determine an angle of arrival from the base station based on the location of the base station and the location of the UE;
calculate an antenna gain between the base station and the UE at the angle of arrival based on the angle of arrival and the antenna gain pattern of the base station;
determine a second pathloss between the base station and the UE based on the first pathloss and the antenna gain; and
apply the second pathloss to determine the initial transmission power of the UE for the location based open loop power control.

3. The UE of claim 2, wherein the processor is further configured to apply the second pathloss to determine the initial transmission power of the UE for the location based open loop power control by determining a minimum of the following as the initial transmission power of the UE:
(i) a maximum output power configured by the UE, and
(ii) a product of an expected receiving power at the base station and the second pathloss.

4. The UE of claim 1, wherein the processor is further configured to:
determine an altitude of the UE;
compare the altitude to an altitude threshold; and
determine whether to adopt the location based open loop power control according to a comparing result.

5. The UE of claim 4, wherein the processor is further configured to:
in response to the comparing result indicating that the determined altitude is larger than the altitude threshold, determine to adopt the location based open loop power control.

6. The UE of claim 4, wherein the processor is further configured to:
in response to the comparing result indicating that the determined altitude is not larger than the altitude threshold, determine to adopt Reference Signal Receiving Power (RSRP) measurement based open loop power control.

7. The UE of claim 4, wherein the processor is further configured to:
receive the altitude threshold broadcast by the base station.

8. The UE of claim 1, wherein the processor is further configured to:
receive, from the base station, an expected receiving power at the base station.

9. The UE of claim 1, wherein the processor is further configured to:
perform Physical Random Access Channel (PRACH) transmission with the initial transmission power.

10. The UE of claim 1, wherein the UE is an Air to Ground (ATG) UE that is Global Navigation Satellite System (GNSS) capable.

11. A method, comprising:
by a user equipment (UE), performing location based open loop power control comprising:
receiving, from a base station, a location and an antenna gain pattern of the base station:
determining a location of the UE:
determining an initial transmission power of the UE for the location based open loop power control based on the location of the UE, the location of the base station and the antenna gain pattern of the base station.

12-13. (canceled)

14. A base station (BS), comprising:
at least one antenna;
at least one radio coupled to the at least one antenna; and
a processor coupled to the at least one radio;
wherein the processor is configured to:
determine a location and an antenna gain pattern of the base station; and
broadcast to a UE the location and the antenna gain pattern of the base station, the location and the antenna gain pattern of the base station being used by the UE along with a location of the UE to determine an initial transmission power of the UE for location based open loop power control.

15. The BS of claim 14, wherein the processor is further configured to:
broadcast an altitude threshold, wherein the UE determines whether to adopt the location based open loop power control according to a comparison result between an altitude of the UE and the altitude threshold.

16. The BS of claim 14, wherein the processor is further configured to:
broadcast a downlink reference signal power and an expected receiving power at the base station.

17. The BS of claim 14, wherein the UE is an ATG UE that is GNSS capable.

18-20. (canceled)
